(19) United States
(12) Patent Application Publication
(10) Pub. No.: US 2004/0162070 A1
(43) Pub. Date: Aug. 19, 2004

(54) Method and apparatus for monitoring and filtering abnormal behavior of mobile stations in a wireless network

(76) Inventors: Elliott Baral, Chicago, IL (US); Richard H. Bradley, Naperville, IL (US); David Albert Rossetti, Randolph, NJ (US); Harold Robert Smith JR., Oakbrook Terrace, IL (US)

Correspondence Address: Richard J. Minnich, Fay, Sharpe, Fagan, Minnich & McKee, LLP, Seventh Floor, 1100 Superior Avenue, Cleveland, OH, 44114, US

(21) Appl. No.: 10/367,482

(22) Filed: Feb. 14, 2003

(51) Int. Cl. H04M 1/00

(52) U.S. Cl. 455/435.1; 455/551

(57) ABSTRACT

This invention relates to a method and apparatus for monitoring and filtering abnormal behavior of mobile stations in a wireless network. More particularly, in one form, the invention is directed to a system to monitor and filter the abnormally high frequency of registrations of a malfunctioning, or rogue, mobile station on a network.

### BACKGROUND OF THE INVENTION

This invention relates to a method and apparatus for monitoring and filtering abnormal behavior of mobile stations in a wireless network. More particularly, in one form, the invention is directed to a system to monitor and filter abnormally high frequency of registrations of a malfunctioning, or rogue, mobile station on a network.

While the invention is particularly directed to and has useful application in the art of filtering undesired registrations on a wireless network, and will be thus described with specific reference thereto, it will be appreciated that the invention may have usefulness in other fields and applications. For example, the invention may be used to monitor and filter any repetitious, abnormal behavior of a mobile station, e.g. an abnormal number of retries within a predefined time interval. The invention may also have application outside of mobile telephony in any system that has behavior analogous to the behavior described herein.

By way of background, a malfunctioning mobile station, or rogue mobile, registers as many times as seven thousand (7,000) times per hour, even after its initial registration is acknowledged by the network. In sharp contrast, a properly functioning mobile station (e.g. mobile phone) attempts to register only until the network acknowledges the registration attempt which typically occurs after only a few attempts. To illustrate, ten (10) attempts to register before network acknowledgment would be an abnormally high number of attempts for a properly functioning mobile station.

The difficulties with rogue mobiles occur at both the mobile station and network levels. The problem for the malfunctioning mobile station is that it is so busy attempting to register on the network that it is unable to actually originate or terminate a call, or data session. The problem for the network is that it must commit unnecessary resources to address this abnormally high number of registrations, or the like. This commitment to the rogue mobile is, of course, to the exclusion of other properly functioning network elements.

Other types of abnormal behavior likewise occur in a mobile environment as a result of a malfunctioning mobile station. As noted above, a mobile station may attempt an abnormally high number of re-tries to originate a call. It will be appreciated that any such abnormal behavior can cause an unnecessary burden on the network and prevent normal functioning of mobile stations.

The present invention contemplates a method and apparatus for monitoring and filtering abnormal behavior of mobile stations in a wireless network that resolves the above-referenced difficulties and others.

### SUMMARY OF THE INVENTION

A method and apparatus for monitoring and filtering abnormal behavior of mobile stations in a wireless network are provided.

In one aspect of the invention, the method comprises steps of a) sequentially recording in a first location electronic serial numbers of mobile stations initiating an event on the network, b) identifying an electronic serial number of a single mobile station that is recorded more than once in the first location at a given time, c) recording an electronic serial number of the single mobile station identified in step b) in a second location and d) identifying the single mobile station if the electronic serial number is recorded in the second location a predetermined number of times within a predetermined period of time.

In another aspect of the invention, the event is autonomous registration.

In another aspect of the invention, the method is performed by a corresponding apparatus and/or system.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates an overall system into which the present invention may be incorporated;

FIG. 2 is a block diagram illustrating an apparatus according to the present invention;

FIG. 3 is a block diagram illustrating an apparatus according to the present invention;

FIG. 4 is a flow chart illustrating a method according to the present invention; and,

FIG. 5 is a flow chart illustrating a method according to the present invention.

### DETAILED DESCRIPTION OF THE PREFERRED EMBODIMENTS

The present invention has an overall objective to provide network elements with a capability to identify abnormal behavior of mobile stations, take real time action (if possible) and initiate off-line action (if necessary). An illustrative example of such abnormal behavior is the repeated attempts of a malfunctioning mobile station to autonomously register on a network. In this case, an objective of the present development is to identify such a mobile station, referred to as a rogue mobile, take real time action such as disabling the rogue mobile (e.g. send the mobile a lock order to turn it off) and initiate off-line action such as alerting the owner of the rogue mobile about the problem and suggesting potential actions the owner can take to address the problem. For example, a special notice may be placed in the owner's monthly bill notifying the owner of the problem and suggesting that the owner bring the mobile into a service provider office for servicing.

Referring now to the drawings wherein the showings are for purposes of illustrating the preferred embodiments of the invention only and not for purposes of limiting same, FIG. 1 provides a view of a network in which the present invention may be implemented. As shown, a network 10 may be accessed by a mobile station 12. A radio access network (RAN) 14 is operative to communicate with the mobile station 12. As those with skill in the art will appreciate, the RAN 14 includes base stations and base transceiver stations (BTSs) with Packet Control Functions (PCFs) that provide a gateway to communication network 16. The communication network 16 likewise includes numerous elements that are well known to those skilled in the art. However, two examples of such elements are a mobile switching center (MSC) 18 and a home location register (HLR) 20. To accommodate packet data traffic, a Packet Data Service Node 22 may also be provided.

The principles and objectives of the present invention may be implemented in a variety of manners depending on the configuration of the network and resources available. In one embodiment, the invention is implemented in a network element, such as mobile switching center (MSC) 18. Of course, the invention may also be implemented in the RAN 14. It is recognized, however, that if the invention is implemented in the MSC 18 (or in a RAN that serves multiple base stations or BTSs), the system preferably delineates between each of the base stations and BTSs for purposes of recording data.

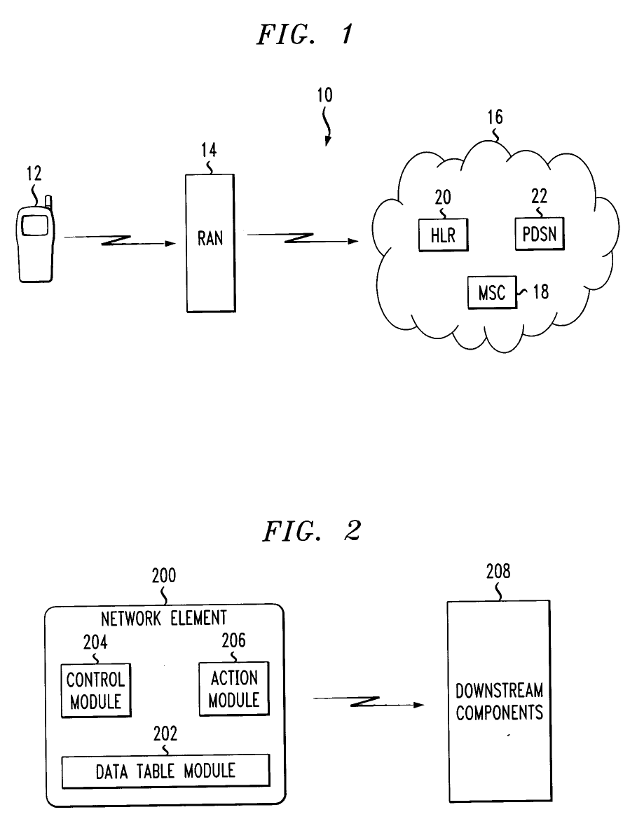

Referring now to FIG. 2, a network element 200 is shown. The network element 200, which is preferably an MSC 18 as noted above, includes a database module 202, a control module 204 and an action module 206.

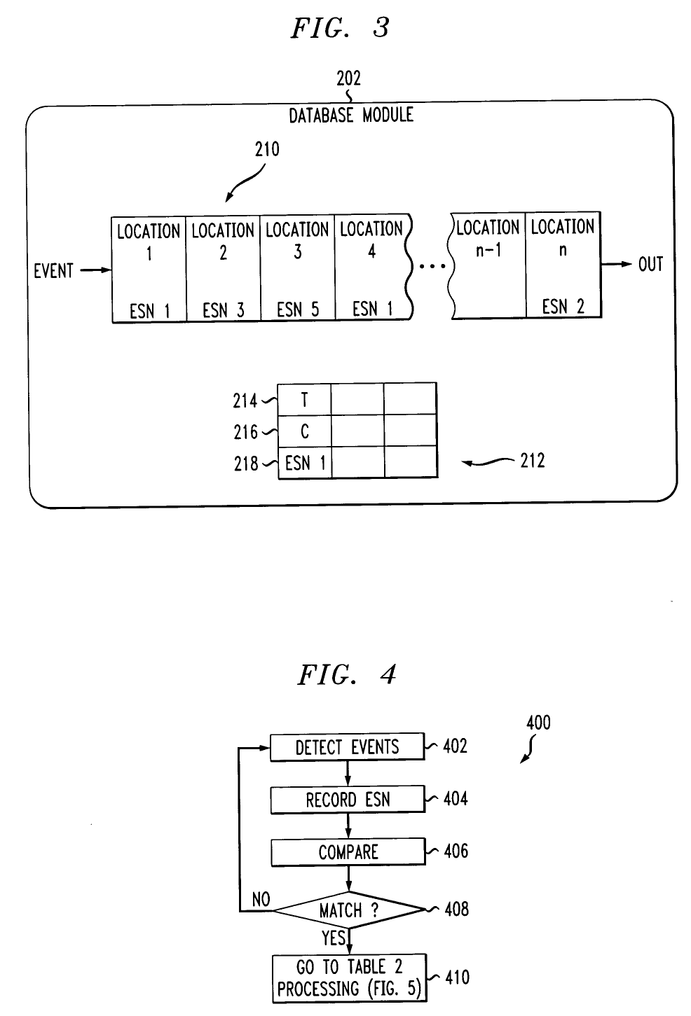

Although it will be more particularly described in connection with FIGS. 3-5, the database module 202 includes a plurality of storage locations (e.g. a first list) for listing or recording particular types of behavior of the mobile stations 12 within the network, such as attempts of mobile stations to autonomously register on the network. This listing is preferably short enough so that mobile stations exhibiting normal behavior will not likely remain on the list long enough to be repeated. However, the list must be long enough so that abnormally frequent behavior will likely repeat before the data expires from the list. The number of storage locations (e.g. n) may be calculated and fixed based on a number of factors including the size of the MSC and engineered traffic problems. In one form, n is 2,000. The database module 202 also includes a second list or listing which is maintained for each type of behavior tracked by the first list. The second list is generated based on the first list. That is, any mobile station whose ESN is on the first list when that mobile station exhibits the tracked behavior is placed on the second list. Thus, the second list identifies the mobile stations that likely exhibit abnormal behavior. Analysis of the second list provides data to support corrective actions that should be taken by the network. For example, mobiles that are listed in the second list may be identified as rogue mobiles.

The control module 204 includes software capable of controlling the database module, as those skilled in the art will appreciate. The method and algorithms implemented by such software are preferably designed to control the recording of the first and second lists, to establish time and count thresholds for use when analyzing the second list and to identify a mobile station exhibiting abnormal behavior.

The action module 206 stores therein a list of actions to be taken by the network to correct the problems of the mobile station that is identified as exhibiting abnormal behavior. This action may be that which occurs in real time as well as off-line action.

As illustrated in FIG. 2, an action identified in action module 206 may be communicated to various downstream components 208 to implement actions to be taken as a result of the recognition of an abnormally behaving mobile station. These actions do not necessarily require implementation in real time but may nonetheless provide useful results. For example, the results may be provided to billing systems to implement appropriate action such as the provision of notice to the user or suggestions on corrective measures that can be taken by the user. Or, it could include notification to the police authorities, or to a service provider's fraud prevention staff.

Referring now to FIG. 3, the database module 202 is illustrated. This module includes, in one embodiment, a first table 210 and a second table 212. The first table 210 is preferably a first-in-first-out type of memory storage component having n locations and capable of recording an event, or tracking behavior, for mobile stations within the network. In a preferred form, the first table has recorded therein electronic serial numbers (ESN) of mobile stations, such as mobile station 12, that attempt to originate or initiate a particular event in the network. Again, an example of such an event is the autonomous registration of mobile stations within a network. Another example of such an event is a retry of a mobile station to originate a call. As those skilled in the art will appreciate, events are recorded in a first-in-first-out basis. So, once the first table is full, detection of a new event moves the oldest entry of data out of the memory device. It should also be understood that an ESN allows a particular physical mobile station to be uniquely identified or determined. As such, any identifier meeting this objective would be suitable to implement the invention.

The second table 212 includes a number of storage locations capable of storing a timestamp (T), a counter value (c), and an electronic serial number (ESN). The number of storage locations to accommodate such data may vary depending on the objectives of the designer.

As alluded to above, the invention is preferably implemented in an MSC. If that is the case, a set of first and second tables may be provided for each cell site within the MSC area—which may also require the transmission of a cell site identification code. Depending on traffic, a single set of first and second tables may also suffice for an MSC implementation.

In addition, if the system, wherever implemented, is configured to monitor and filter different types of events, then different sets of tables would be desired for each type of event. Moreover, the control software may also be adapted to account for the different events.

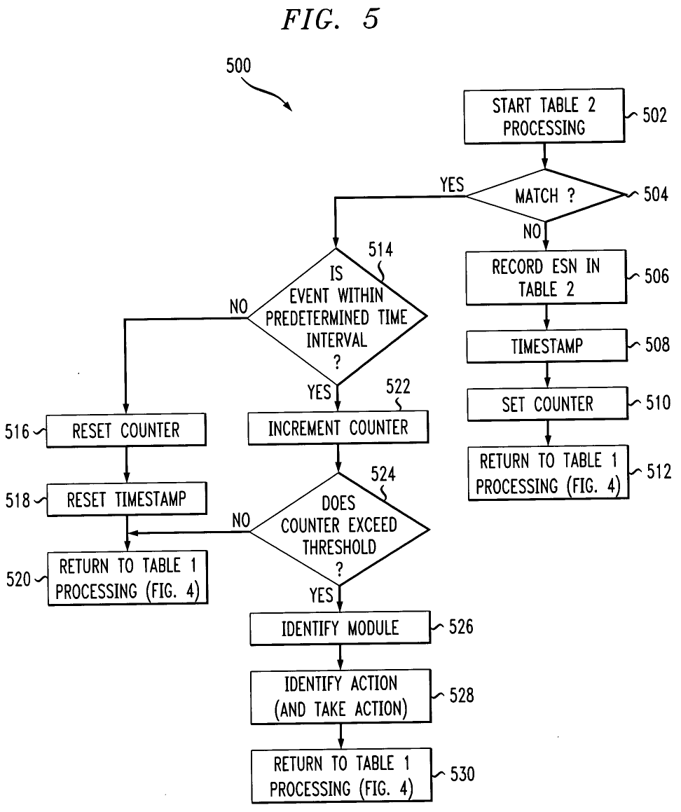

In operation (which will be more specifically described in connection with FIGS. 4-5), the control software stored in the control module 204 (FIG. 2) allows the database module 202 to record electronic serial numbers of mobile stations originating or initiating an event on the network such an autonomous registration. As each event is recorded, a comparison is made to determine if the electronic serial number of the mobile station is recorded more than once in the first table. If so, the identified electronic serial number is then stored in the second table along with a timestamp (T) and a counter value (c). If subsequent attempts are made by the same mobile station, these are recorded in the first table and, if the first table also holds the ESN from a previous attempt, it is recorded in the second table by incrementing the counter. If the event, e.g. attempt to autonomously register, occurs more than a predetermined number of times within a predetermined period of time, then the mobile station is identified as one that exhibits abnormal behavior. Of course, the thresholds for the period of time and number of occurrences is set in the control software module 204 and may be different for each different type of behavior being tracked. Depending on the abnormal behavior being tracked, the action module 206 then identifies an action to be taken by the network to address the abnormality.

It should be understood that, in the case of rogue mobiles, the first table stores the electronic serial numbers of all mobile stations attempting to register on the network. If an electronic serial number is stored more than once in the table, the mobile station is identified as a possible rogue mobile by virtue of the recording of its electronic serial number in the second table. If a mobile continuously attempts to register on the network, then the counter stored in the second table will be incremented. If the counter exceeds the threshold within the time period allotted, the mobile will be identified as a rogue mobile. In one example, the rogue mobile may be turned off by virtue of the system sending a lock order to the mobile.

More particularly, with reference to FIG. 4, a method 400 according to the present invention includes the step of detecting events (step 402). The electronic serial numbers of the mobile stations attempting to originate the events are then recorded in a first table or Table 1 (step 404). The electronic serial number that is being recorded is compared to those electronic serial numbers already recorded in Table 1 (step 406). A determination is then made as to whether the electronic serial number to be recorded matches previously stored electronic serial numbers (step 408). If not, the system simply continues its efforts to detect events. If, however, a match does occur, processing for the second table, or Table 2, is implemented (step 410).

It is to be recognized that a variety of software techniques may be utilized to implement the steps of the method of FIG. 4, as well as those steps identified in connection with FIG. 5. In this regard, the system may well continue with detecting events (beginning at step 402) while the processing for Table 2 is implemented. However, for ease of understanding, the description herein will not specifically address such multi-tasking and will be described to simply clarify the steps of the overall method.

Referring now to FIG. 5, the method 500 for processing data in Table 2 is illustrated. Initially, if an electronic serial number is found to occur in Table 1 more than once, Table 2 processing is initiated (step 502). It is first determined whether the electronic serial number has already been recorded in Table 2 (step 504). If not, the electronic serial number is recorded in Table 2 (step 506) and timestamped (step 508). Also, the counter is set, preferably to one (1) (step 510). Processing is then returned to Table 1 processing associated with FIG. 4 (step 512).

If the electronic serial number is found to have already been recorded in the second table, i.e. Table 2, it is determined whether the subject event occurred within a predetermined time interval (step 514). In one embodiment, this can be accomplished by simply comparing the present time t to the timestamp T to determine if the difference exceeds a threshold or not. If it is determined that the subject event did not occur within a predetermined amount of time from the last recording of a similar event, then the counter is reset to one (step 516) and the timestamp is set to t (step 518). Processing is then returned to process the information in Table 1 (step 520).

If it is determined in step 514 that a subject event has occurred within a predetermined time interval, the counter is incremented (step 522). A determination is then made as to whether the counter exceeds a predetermined threshold (step 524). If not, processing is simply returned to the processing for Table 1 (step 520). If, however, the counter does exceed a predetermined threshold, the mobile station having the electronic serial number of interest is identified as a mobile station exhibiting abnormal behavior (step 526). Action is then taken by the network based on this determination (step 528). Processing is then returned to Table 1 processing (step 530).

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for use in a network comprising steps of:
sequentially recording in a first location electronic serial numbers of mobile stations initiating an event on the network, the first location having n storage portions to store the electronic serial numbers corresponding to the n most recent attempts of the mobile stations to originate the event on the network;
identifying an electronic serial number of a single mobile station that is recorded more than once in the first location at a given time;
recording the electronic serial number of the single mobile station in a second location; and,
identifying the single mobile station if the electronic serial number is recorded in the second location a predetermined number of times within a predetermined period of time.

2. The method as set forth in claim 1 wherein the recording includes generating a timestamp identifying an initial recording of the electronic serial number of the single mobile station in the second location.

3. The method as set forth in claim 1 wherein the recording includes incrementing a counter in the second table identifying a number of times that the electronic serial number of the single mobile station is recorded in the second location within the predetermined period of time.

4. The method as set forth in claim 1 wherein the event is autonomous registration.

5. The method as set forth in claim 1 wherein n is approximately two thousand (2,000).

6. The method as set forth in claim 1 wherein the identifying of the electronic serial number of the single mobile station that is recorded more than once in the first location comprises comparing the electronic serial number corresponding to the most recent attempt to autonomously register with the electronic serial numbers recorded in the first location.

7. The method as set forth in claim 1 further comprising identifying an action to be taken based on identifying the single mobile station.

8. An apparatus for use in a network, the apparatus comprising:
first means for recording electronic serial numbers of mobile stations attempting to originate an event on the network, the first recording means having n storage locations to store the electronic serial numbers corresponding to the n most recent attempts of the mobile stations to originate the event on the network;
first means for identifying an electronic serial number of a single mobile station that is recorded more than once in the sequential storing means at a given time;
second means for recording the electronic serial number of the single mobile station; and,
second means for identifying the single mobile station if the electronic serial number is recorded in the second recording means a predetermined number of times within a predetermined period of time.

9. The apparatus as set forth in claim 8 wherein the second recording means includes means for generating a timestamp identifying an initial recording of the electronic serial number of the single mobile station in the second recording means.

10. The apparatus as set forth in claim 8 wherein the second recording means includes a counter identifying a number of times that the electronic serial number of the single mobile station is recorded within the predetermined period of time.

11. The apparatus as set forth in claim 8 wherein the event is autonomous registration.

12. The apparatus as set forth in claim 8 wherein n is approximately two thousand (2,000).

13. The apparatus as set forth in claim 8 wherein the first means for identifying the electronic serial number of the single mobile station that is recorded more than once comprises means for comparing the electronic serial number corresponding to the most recent attempt to autonomously register with the electronic serial numbers recorded in the first recording means.

14. The apparatus as set forth in claim 8 further comprising an action module operative to store actions to be taken based on the second means for identifying.

15. A method for use in a network comprising steps of:
sequentially recording in a first table electronic serial numbers of mobile stations attempting to autonomously register on the network, the first table having n storage locations to store the electronic serial numbers corresponding to the n most recent attempts of the mobile stations to autonomously register on the network;
identifying an electronic serial number of a single mobile station that is recorded more than once in the first table at a given time;
recording the electronic serial number of the single mobile station in a second table; and,
identifying the single mobile station if the electronic serial number is recorded in the second table a predetermined number of times within a predetermined period of time.

16. The method as set forth in claim 15 wherein the recording includes generating a timestamp identifying an initial recording of the electronic serial number of the single mobile station in the second table.

17. The method as set forth in claim 15 wherein the recording includes incrementing a counter in the second table identifying a number of times that the electronic serial number of the single mobile station is recorded in the second table within the predetermined period of time.

18. The method as set forth in claim 15 wherein n is approximately two thousand (2,000).

19. The method as set forth in claim 15 wherein the identifying of the electronic serial number of the single mobile station that is recorded more than once in the first table comprises comparing the electronic serial number corresponding to the most recent attempt to autonomously register with the electronic serial numbers recorded in the first table.

20. The method as set forth in claim 15 further comprising identifying an action to be taken based on identification of the single mobile station.

21. An apparatus for use in a network, the apparatus comprising:
first means for recording electronic serial numbers of mobile stations attempting to autonomously register on the network, the first recording means having n storage locations to store the electronic serial numbers corresponding to the n most recent attempts of the mobile stations to autonomously register on the network;
first means for identifying an electronic serial number of a single mobile station that is recorded more than once in the sequential storing means at a given time;
second means for recording the electronic serial number of the single mobile station; and,
second means for identifying the single mobile station if the electronic serial number is recorded in the second recording means a predetermined number of times within a predetermined period of time.

22. The apparatus as set forth in claim 21 wherein the second recording means includes means for generating a timestamp identifying an initial recording of the electronic serial number of the single mobile station in the second recording means.

23. The apparatus as set forth in claim 21 wherein the second recording means includes a counter identifying a number of times that the electronic serial number of the single mobile station is recorded in the second table within the predetermined period of time.

24. The apparatus as set forth in claim 21 wherein n is approximately two thousand (2,000).

25. The apparatus as set forth in claim 21 wherein the first means for identifying the electronic serial number of the single mobile station that is recorded more than once in the first table comprises means for comparing the electronic serial number corresponding to the most recent attempt to autonomously register with the electronic serial numbers recorded in the first recording means.

26. The apparatus as set forth in claim 21 further comprising an action module to store actions to be taken based on the second identifying means output.
